(19) United States
(12) Patent Application Publication
(10) Pub. No.: US 2024/0360938 A1
(43) Pub. Date: Oct. 31, 2024

(54) Automatic Fluid Flow System with Retractable Connection

(71) Applicant: C. R. Bard, Inc., Franklin Lakes, NJ (US)

(72) Inventors: Jason Jishen Cheng, Avondale Estates, GA (US); Rohit Sinha, Lawrenceville, GA (US); Michal Tourchak, Atlanta, GA (US)

(21) Appl. No.: 18/765,516

(22) Filed: Jul. 8, 2024

Related U.S. Application Data
(63) Continuation of application No. 17/373,546, filed on Jul. 12, 2021, now Pat. No. 12,055,249.
(60) Provisional application No. 63/054,694, filed on Jul. 21, 2020.

(51) Int. Cl. F16L 37/12; G01G 17/04

(52) U.S. Cl. CPC F16L 37/12; G01G 17/04

(57) ABSTRACT

An automatic fluid flow measuring system for detecting a fluid weight change of a fluid collection system includes a load cell configured to detect a downward force and a ring connector configured to releasably couple to the load cell. The load cell can include a plate movable along a transverse axis orthogonal to a face of the plate. The plate can include a first electrical contact. The ring connector is configured to transition between an unlocked position and a locked position on the load cell. The ring connector can include a second electrical contact configured to communicate with the first electrical contact in the locked position.

### PRIORITY

This application is a continuation of U.S. patent application Ser. No. 17/373,546, filed Jul. 12, 2021, which claims the benefit of priority to U.S. Provisional Application No. 63/054,694, filed Jul. 21, 2020, each of which is incorporated by reference in its entirety into this application.

### SUMMARY

Briefly summarized, embodiments disclosed herein are directed to automatic fluid flow system connectors and the like. In order to maintain a high accuracy of fluid flow monitoring, automatic fluid flow systems can determine a change in fluid volume by detecting a change in weight of a fluid collection system, over time. These detection systems rely on precise weight measurements to provide high accuracy of fluid flow in low-flow situations. As such, interface mechanisms configured to engage the fluid collection system with the automatic fluid flow system require a secure fit to ensure the downward forces, or changes thereof, are accurately transferred to the automatic fluid flow system. Further, the interface mechanisms must sustain repeated engagements and disengagements as different fluid collection systems are coupled/uncoupled to the automatic fluid flow system.

Disclosed herein is an automatic fluid flow measuring system including, a load cell having a first electrical contact disposed on a front surface of a plate, and transitionable along a transverse axis between an engaged position and a disengaged position, the transverse axis extending perpendicular to the front surface of the plate, and a ring connector configured to be coupled to a fluid collection system and including a second electrical contact disposed on a rear surface and configured to engage the first electrical contact in the engaged position, the ring connector configured to be releasably coupled to the load cell and transitionable between an unlocked position and a locked position.

In some embodiments, the load cell includes a biasing member configured to bias the plate towards the engaged position. In some embodiments, the ring connector engages the load cell along the transverse axis in the unlocked position and rotates about the transverse axis to the locked position. In some embodiments, one of the plate or the ring connector includes an alignment pin extending therefrom and configured to transition the plate from an engaged position to a disengaged position when the ring connector is coupled with the load cell in the unlocked position. In some embodiments, one of the ring connector or the load cell includes an alignment groove configured to receive the alignment pin in the locked position and to allow the plate to transition from the disengaged position to the engaged position.

In some embodiments, the load cell includes a flange extending radially and defining a first diameter, the ring connector including a recess configured to receive the flange therein. In some embodiments, the ring connector includes a tab extending radially inward from a rim of the recess to define a second diameter less than the first diameter, the flange including a slot configured to receive the tab therethrough in the unlocked position. In some embodiments, the tab is configured to rotate about the transverse axis to engage the flange in the locked position. In some embodiments, the automatic fluid flow measuring system further includes an O-ring extending annularly around one of the first electrical contact or the second electrical contact and configured to engage the ring connector and load cell in a locked position to provide a fluid tight seal therebetween. In some embodiments, the automatic fluid flow measuring system further includes a magnetic locking system configured to releasably couple the ring connector to the load cell.

Also disclosed is a method of measuring a fluid flow including, providing a load cell having a first electrical contact disposed on a plate, transitionable between a disengaged position and an engaged position, and a ring connector coupled to a fluid collection system and including a second electrical contact disposed within a recess, urging the ring connector along a transverse axis until the plate is disposed within the recess, rotating the ring connector about the transverse axis, transitioning the plate from a disengaged position to an engaged position, transferring a force from the ring connector to the load cell, and determining a fluid flow by determining a change in force over time.

In some embodiments, the force is transferred from the ring connector to the load cell along a second axis extending perpendicular to the transverse axis. In some embodiments, the first electrical contact engages the second electrical contact in the engaged position. In some embodiments, the first electrical contact engages the second electrical along the transverse axis. In some embodiments, the recess includes a tab extending radially inward and the load cell includes a flange extending radially outward, the flange including a slot configured to receive with the tab therethrough to allow the flange to be received within the recess along the transverse axis in an unlocked position. In some embodiments, rotating the ring connector engages the tab with the flange to releasably couple the ring connector to the load cell in a locked position. In some embodiments, the method further includes engaging an alignment pin with a surface of one of the recess or the plate to transition the plate from the engaged position to the disengaged position, the alignment pin extending from one of the plate or the recess. In some embodiments, the method further includes aligning the alignment pin with an alignment groove to transition the plate from the disengaged position to the engaged position. In some embodiments, the method further includes a biasing member configured to bias the plate to the engaged position.

### BRIEF DESCRIPTION OF DRAWINGS

A more particular description of the present disclosure will be rendered by reference to specific embodiments thereof that are illustrated in the appended drawings. It is appreciated that these drawings depict only typical embodiments of the invention and are therefore not to be considered limiting of its scope. Example embodiments of the invention will be described and explained with additional specificity and detail through the use of the accompanying drawings in which:

FIG. 1A shows a perspective view of an exemplary automatic fluid flow system including a fluid collection system, in accordance with embodiments disclosed herein.

FIGS. 1B-1C show perspective views of a load cell interface and a ring connector of an exemplary automatic fluid flow system, in accordance with embodiments disclosed herein.

FIG. 2A shows a perspective view of a load cell interface, in accordance with embodiments disclosed herein.

FIG. 2B shows a perspective view of a ring connector, in accordance with embodiments disclosed herein.

FIG. 2C shows a cross-section view of a ring connector and a load cell interface in an uncoupled position, in accordance with embodiments disclosed herein.

FIG. 2D shows a cross-section view of a ring connector coupled to a load cell interface in an unlocked position, in accordance with embodiments disclosed herein.

FIG. 2E shows a cross-section view of a ring connector coupled to a load cell interface in a locked position, in accordance with embodiments disclosed herein.

FIG. 2F shows a cross-section view of a ring connector coupled with a load cell interface in an unlocked position, in accordance with embodiments disclosed herein.

FIG. 2G shows a cross-section view of a ring connector coupled with a load cell interface in a locked position, in accordance with embodiments disclosed herein.

### DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

### Terminology

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Singular forms of “a,” “an,” and “the” include plural references unless the context clearly dictates otherwise.

In the following description, certain terminology is used to describe aspects of the invention. For example, in certain situations, the term “logic” is representative of hardware, firmware or software that is configured to perform one or more functions. As hardware, logic may include circuitry having data processing or storage functionality. Examples of such circuitry may include, but are not limited or restricted to a hardware processor (e.g., microprocessor with one or more processor cores, a digital signal processor, a programmable gate array, a microcontroller, an application specific integrated circuit “ASIC,” etc.), a semiconductor memory, or combinatorial elements.

Alternatively, logic may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” should be construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: a server, an endpoint device (e.g., a laptop, a smartphone, a tablet, a “wearable” device such as a smart watch, augmented or virtual reality viewer, or the like, a desktop computer, a netbook, a medical device, or any general-purpose or special-purpose, user-controlled electronic device), a mainframe, internet server, a router; or the like.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

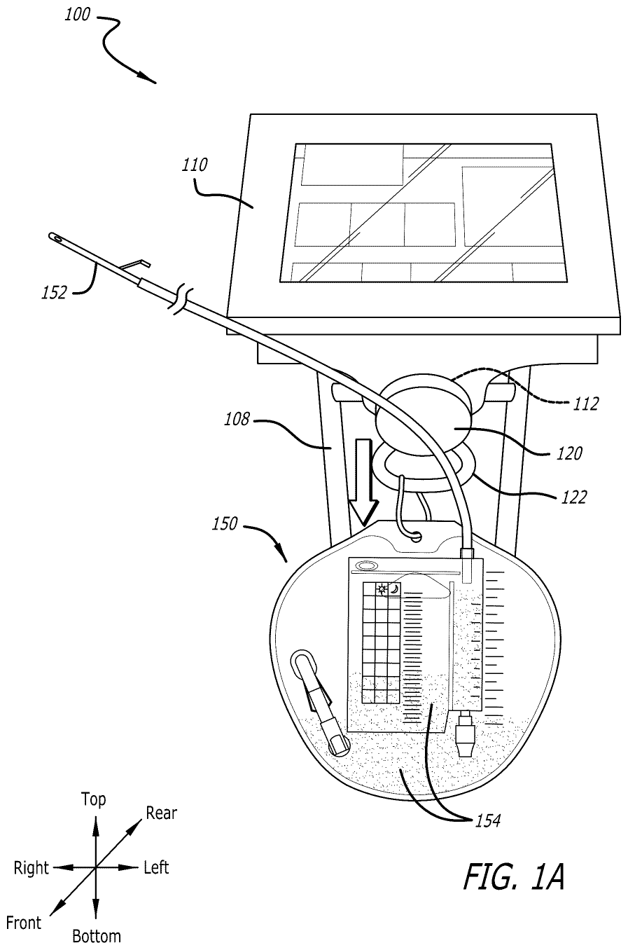

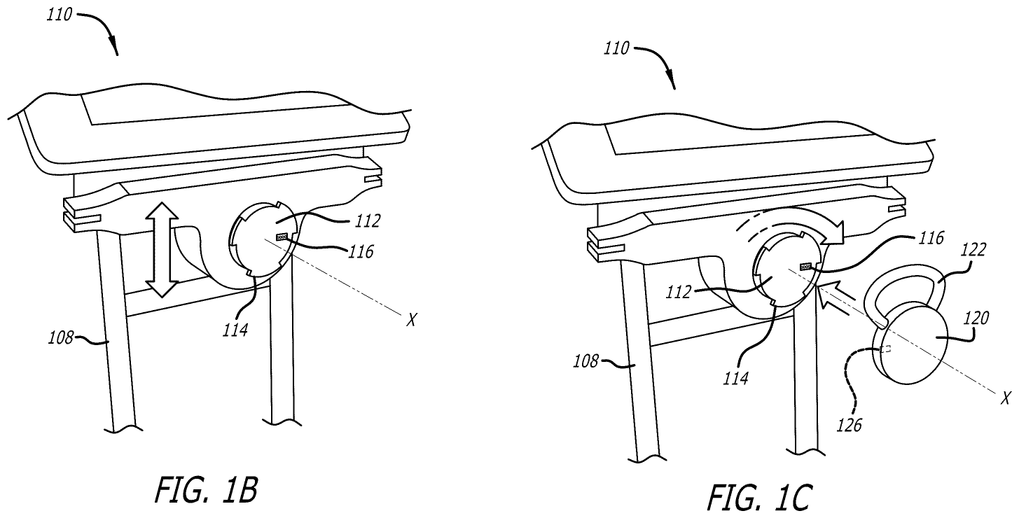

Labels such as “left,” “right,” “upper”, “lower,” “top,” “bottom,” “front,” “back,” and the like are used for convenience and are not intended to imply, for example, any particular fixed location, orientation, or direction. Instead, such labels are used to reflect, for example, relative location, orientation, or directions. To assist in the description of embodiments described herein, the “top,” “bottom,” “left,” “right,” “front” and “back” directions are in reference to the orientation of the device as shown in FIG. 1A. A vertical axis extends between a top direction and a bottom direction. A lateral axis extends horizontally between a left direction and a right direction, substantially normal to the vertical axis. A transverse axis extends horizontally between a front direction and a back direction, substantially normal to both the vertical and lateral axes. A horizontal plane is defined by the lateral and transverse axes. A median plane is defined by the vertical and transverse axes. A frontal plane is defined by the vertical and lateral axes.

Unless defined otherwise, all technical and scientific terms used herein have the same meaning as commonly understood by those of ordinary skill in the art.

FIGS. 1A-1C show details of an exemplary automatic fluid flow measuring system (“system”) 100 including a fluid collection system 150 coupled thereto, in accordance with embodiments disclosed herein. The automatic fluid flow system 100 generally includes a console 110 including a load cell interface (“load cell”) 112 configured to engage a ring connector (“ring”) 120. The ring connector 120 can include a loop 122, peg, hook, or similar structure from which a fluid collection system 150 can be suspended. The fluid collection system 150 can generally include one or more collection containers 154 in fluid communication with a catheter 152 or similar device configured to drain a fluid from a cavity of a patient. Optionally, the console 110 can be supported by a stand 108, or similar structure configured to support the console 110, ring 120, fluid collection system 150, and the like.

In an embodiment, the catheter 152 can be an internal catheter or an external catheter. Exemplary catheters can include external urinary catheter, internal urinary catheter, Foley catheter, balloon catheter, peritoneal catheters, or the like. Exemplary fluids collected can include urine, blood, peritoneal fluid, interstitial fluid, or the like. In an embodiment, the catheter 152 can be a Foley catheter configured to drain a fluid, e.g. urine, from a bladder of a patient.

As shown in FIG. 1B, the load cell interface 112 can be configured to detect a change in vertical movement relative to the console 110. In an embodiment, the load cell interface 112 can be configured to detect a force applied thereto, along an axis extending parallel to a front surface of the load cell 112, or perpendicular to a central transverse axis (x) of the load cell. For example, as shown in FIG. 1C, a ring connector 120 can be coupled to the load cell interface 112 by engaging the load cell 112 along the central transverse axis (x). The ring connector 120 can then be locked to the load cell 112 by rotating the ring connector 120 about the central transverse axis (x). In an embodiment, the ring connector 120 can be rotated between 5° and 360°. In an embodiment, the ring connector 120 can be rotated substantially 180°.

A fluid collection system 150 can then be coupled to the loop 122 of the ring connector 120. A change in fluid volume within the fluid collection system 150, and thereby a change in weight thereof, causes a change in force applied to the load cell interface 112. The change in force can be substantially along a vertical axis, however it will be appreciated that the load cell interface 112 can detect force changes along other axes in three-dimensional space, as well. The change in force applied to the load cell interface 112 can be detected by the console 110 to determine a change in fluid volume within the fluid collection system 150. This information can then be stored, analyzed, displayed, or communicated to one or more external computing devices or networks, e.g. an Electronic Health Record (EHR) system, network, or the like.

In an embodiment, the load cell interface 112 can include a locking mechanism 114 and an electrical contact interface 116. The locking mechanism 114 can be configured to engage a corresponding locking mechanism disposed on the ring connector 120 to secure the ring connector 120 to the load cell interface 112, as described in more detail herein. As noted, the locking mechanism 114 can be a rotational locking mechanism 114 where the ring connector 120 is rotated through a frontal plane by substantially 180° to transition the ring connector between a locked configuration (FIG. 1A) and an unlocked configuration (FIG. 1C).

In an embodiment, the electrical contact interface 116 can be configured to engage a corresponding electrical contact interface 126 disposed on the ring connector 120 to communicatively couple the ring connector 120 to the load cell interface 112 of the console 110. In an embodiment, the ring connector electrical contact interface 126 engages the load cell electrical contact interface 116 in one of the locked configuration or the unlocked configuration.

In an embodiment, the ring connector 120 can include one or more processors, memory, storage logic, communication logic, or the like, configured to store information and communicate with the console 110 by way of the ring connector electrical contact interface 126 and the load cell electrical contact interface 116. For example, the ring connector 120 can store fluid flow information, system information, patient information, or the like. Fluid flow information can include current or historical fluid volume information, fluid flow information (i.e. change in volume over time), combinations thereof or the like. System information can include the make, model, serial number, etc. of the ring connector 120, fluid collection system 150, the console 110, components thereof, or the like. Patient information can include height, weight, blood pressure, etc. of the patient, or similar health record information.

Advantageously, the fluid flow information, system information, patient information, and the like, can be stored to the ring connector 120 and transported with the collection system 150 and patient. The ring connector 120 and collection system 150 assembly can then be coupled to a different console 110, e.g. during transport or console malfunction, and continue to measure fluid flow without losing the historical data, or transferring the data separately. As such, the data remains with the patient and the collection system 150 and is not lost.

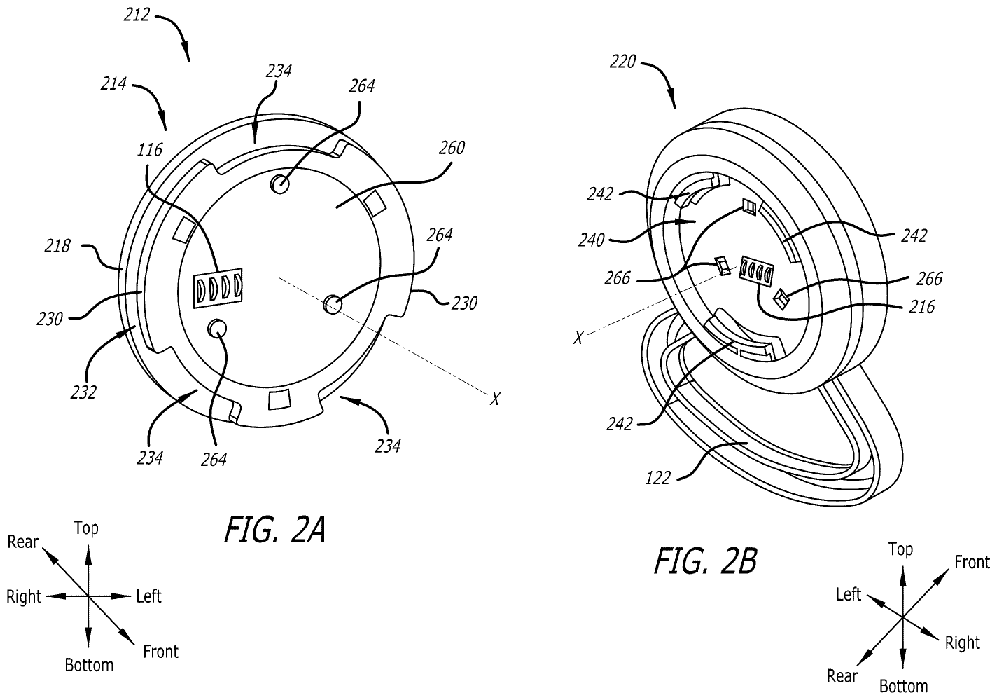

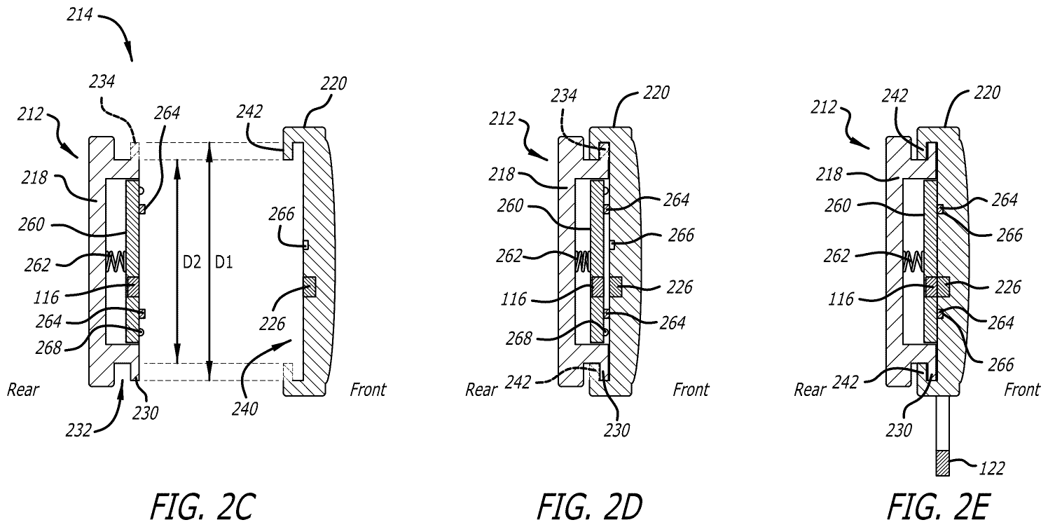

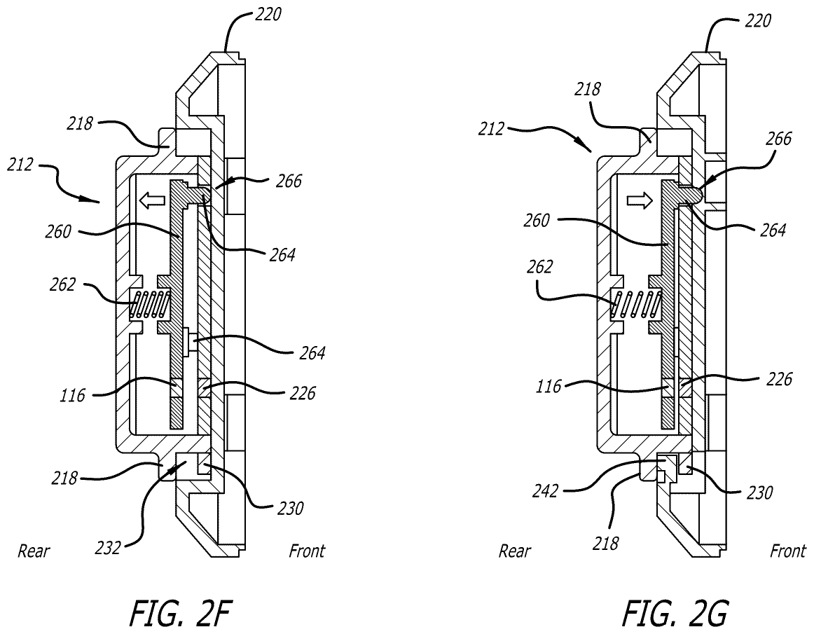

FIGS. 2A-2G show embodiments of a load cell interface 212 and a ring connector 220 including a retractable plate locking mechanism 214 configured to releasably engage the ring connector 220 with the load cell 212. The load cell 212 can define a front surface, a rear surface and a side surface extending therebetween. The ring connector 220 can define a front surface, a rear surface and a side surface extending therebetween. To note, while one of the load cell 212 or the ring connector 220 can define a circular shaped front surface or rear surface, it will be appreciated that other closed curve, regular or irregular polygonal shapes are also contemplated including triangular, square, hexagonal, or the like.

In an embodiment, the retractable plate locking mechanism 214 can include a bayonet engagement mechanism having a movable plate 260 transitionable between an unlocked position (FIG. 2D) and a locked position (FIG. 2E). As shown in FIGS. 2A and 2C, the load cell 212 can include a flange 230 extending radially from a central transverse axis (x), substantially parallel to a front surface of the load cell 212, and extending annularly about the front surface of the load cell 212. The flange 230 can define a track 232 extending annularly, between the flange 230 and a body 218 of the load cell 212. The flange 230 can define a first diameter (D1), and the track 232 can define a second diameter (D2) which is less than the first diameter (D1). The flange 230 can include one or more slots 234 extending transversely through the flange 230 and configured to allow access to the track 232, as described in more detail herein.

In an embodiment, the rear surface of the ring connector 220 can include a recess 240 configured to receive the flange 230 therein. The recess 240 can define a diameter that is substantially equal to, or greater than, the first diameter (D1). The recess 240 can further include one or more tabs 242 extending radially inward from a rim of the recess 240. A diametric distance between the inner edge of the tabs 242 can be equal to, or slightly larger than, the second diameter (D2) of the track 232 and can be less than the first diameter (D1). In an embodiment, the tab(s) 242 can align with the slot(s) 234 along a transverse axis to allow the flange 230 to be received within the recess 240 (FIG. 2D). The ring connector 220 can then be rotated about the central transverse axis (x) until the tab 242 engages the flange 230 in a bayonet fit engagement, securing the ring connector 220 to the load cell 212 in a locked position (FIG. 2E).

As such, the load cell 212 includes a male bayonet connection and the ring connector 220 includes a female bayonet connection. It will be appreciated, however, that embodiments can further include the load cell 212 with a female bayonet connection and the ring connector 220 with a male bayonet connection without departing from the spirit of the invention.

In an embodiment, as shown in FIGS. 2C-2G, the load cell 212 includes a retractable plate (“plate”) 260 that is slidably engaged with the load cell 212 along a transverse axis between an engaged position (FIGS. 2C, 2E, 2G) and a disengaged position (FIGS. 2D, 2F). As noted, while embodiments as shown include the load cell 212 having the plate 260 it will be appreciated that embodiments can include the ring connector 220 having the retractable plate 260 without departing from the spirit of the invention.

In an embodiment, the load cell 212 can further include a biasing member 262, e.g. a compression spring or the like, configured to bias the plate 260 towards an engaged position (FIGS. 2C, 2E, 2G). In an embodiment, the load cell 212 can include an electrical contact 116 disposed on the front surface of the plate 260. The plate 260 can further include one or more alignment pins 264 extending from the front surface of the plate 260. The ring connector 220 can include one or more alignment grooves 266 disposed in a rear surface of the ring connector 220, e.g. within the recess 240, and each configured to receive an alignment pin 264 therein. The alignment grooves 266 can further include a chamfered edge to facilitate engagement or disengagement of the alignment pin 264 therefrom.

The alignment grooves 266 can be configured to align with the alignment pins 264 when the ring connector 220 is in the locked position (FIGS. 2E, 2G). Similarly, the alignment grooves 266 can be configured to be misaligned with the alignment pins 264 when the ring connector 220 is in the unlocked position (FIGS. 2D, 2F). In an embodiment, the tab(s) 242 can align with the slot(s) 234 to allow the flange 230 to be received within the recess 240 in an unlocked position. As such, the alignment pins 264, which are misaligned with the alignment grooves 266 in this position, engage with a surface of the ring connector 220, e.g. a surface of the recess 240 and transition the plate 260 from the engaged position (FIG. 2C) to the disengaged position (FIG. 2D). The ring connector 220 can then be rotated about the central transverse axis (x) from the unlocked position (FIGS. 2D, 2F) where the tabs 242 align with the slots 234, to a locked position (FIGS. 2E, 2G) where the tabs 242 engage the flange 230. In the locked position, the alignment pins 264 align with the alignment grooves 266 to allow the biasing member 262 to transition the plate 260 from the disengaged position (FIGS. 2D, 2F) to the engaged position (FIGS. 2E, 2G). This allows the load cell electrical contacts 116 to engage the ring connector electrical contacts 226 along a transverse axis as the ring connector 220 is rotated to the locked position.

In like manner, to disengage the ring connector 220 from the load cell 212, the ring connector 220 can be rotated about the central transverse axis (x) from the locked position (FIGS. 2E, 2G) where the tabs 242 engage the flange 230, to the unlocked position (FIGS. 2D, 2G), where the tabs 242 align with the slots 234. As the ring connector 220 is rotated, the alignment pins 264 disengage the alignment grooves 266 and transition the plate 260 from the engaged position to the disengaged position, disengaging the load cell electrical contacts 116 from the ring connector electrical contacts 126 along the transverse axis. The ring connector 220 can then be uncoupled from the load cell 212 by withdrawing the ring connector 220 along the central transverse axis (x). The biasing member 262 can then reset the plate 260, transitioning the plate 260 to the engaged the position.

Advantageously, the retractable plate locking mechanism 214 prevents the electrical contacts 116, 226 from dragging over each other, i.e. along an axis extending perpendicular to the transverse axis, as the ring connector 220 is rotated between the locked position and the unlocked position. Instead the electrical contacts 116, 226 engage along the transverse axis that extends perpendicular to the front surface of the load cell 212, or the rear surface of the ring connector 220 on which the electrical contacts 116, 226 are disposed. Worded differently, the electrical contacts 116, 226 engage along the transverse axis that extends perpendicular to a direction of rotation and mitigates wear and damage to the electrical contacts 116, 226 extending the usable life of the system 100.

In an embodiment, one of the ring connector 220 or the load cell 212 can include an O-ring 268 or similar grommet extending annularly along an edge of the plate 260 or recess 240 and configured to encircle the electrical contacts 116, 226 when in the locked position. In an embodiment, the O-ring 268 extends annularly along a front surface of the plate 260 and can engage a surface of the recess 240 of the ring connector 220 when in the locked configuration. However, it will be appreciated that other configurations of the O-ring 268 are also contemplated. Advantageously, the O-ring 268 can engage the ring connector 220 and the load cell 212 in the locked position and provide a fluid-tight seal therebetween. This prevents any fluid from accessing the electrical contacts 116, 226, and causing a short-circuit, or similar damage to the system 100.

While embodiments disclosed herein show a retractable plate locking mechanism 214 including a bayonet locking mechanism, it will be appreciated that the retractable plate locking mechanism 214 can include other locking mechanisms configured to secure the ring connector 220 to the load cell 212 without departing from the spirit of the invention. For example, the ring connector 220 can be secured to the load cell 212 by a magnetic system, e.g. permanent magnet, electromagnet, or the like and rotated as described herein to engage or disengage the plate 260. These and similar locking mechanisms are contemplated to fall within the scope of the present invention.

In an exemplary method of use, a load cell 212 and a ring connector 220 including a retractable plate locking mechanism 214 can be provided, as described herein. A user can align the tabs 242 of the ring connector 220 with the slots 234 of the flange 230 and urge the ring connector 220 along a central transverse axis (x) to couple the ring connector 220 with the load cell 212. As the flange 230 is received into the recess 240, the alignment pins 264, which are misaligned with the alignment grooves 266, engage the rear surface of the ring connector 220 and transition the plate 260 from the engaged position to the disengaged position. Advantageously this prevents the load cell electrical contacts 116 from engaging a rear surface of the ring connector 220, recess 240, or the like, and being dragged thereover as the ring connector 220 is rotated. This prevents damage and wear to the load cell electrical contacts 116 prolonging the usable life of the system 100.

The ring connector 220 can then be rotated to a locked position, by rotating the ring connector about the central transverse axis (x) until a tab 242 engages the flange 230 and an alignment pin 264 aligns with an alignment groove 266 allowing the biasing member 262 to transition the plate 260 from the disengaged position to the engaged position. This allows the load cell electrical contacts 116 to engage the ring connector electrical contacts 226 along the transverse axis communicatively coupling the ring connector 220 with the load cell 212.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. An automatic fluid flow measuring system for detecting a fluid weight change of a fluid collection system, comprising:
a console;
a load cell coupled to the console and configured to detect a downward force, the load cell comprising a plate movable along a transverse axis orthogonal to a face of the plate, the plate including a first electrical contact; and
a ring connector configured to releasably couple to the load cell, the ring connector configured to transition between an unlocked position and a locked position on the load cell, the ring connector including a second electrical contact configured to communicate with the first electrical contact in the locked position.

2. The automatic fluid flow measuring system according to claim 1, wherein the load cell includes a biasing member configured to bias the plate away from the console.

3. The automatic fluid flow measuring system according to claim 1, wherein the ring connector is rotatable between the unlocked position and the locked position.

4. The automatic fluid flow measuring system according to claim 1, wherein one of the plate or the ring connector includes an alignment pin, and wherein the other of the plate or the ring connector includes an alignment groove, wherein the alignment groove is configured to receive the alignment pin in the locked position.

5. The automatic fluid flow measuring system according to claim 1, wherein the ring connector is configured to releasably couple to the load cell via magnetic attraction.

6. The automatic fluid flow measuring system according to claim 1, wherein the load cell includes a flange extending radially and defining a first diameter, the ring connector including a recess configured to receive the flange.

7. The automatic fluid flow measuring system according to claim 6, wherein the ring connector includes a tab extending radially inward from a rim of the recess to define a second diameter less than the first diameter, the flange including a slot configured to receive the tab in the unlocked position.

8. The automatic fluid flow measuring system according to claim 7, wherein the tab is configured to rotate about the transverse axis to engage the flange in the locked position.

9. The automatic fluid flow measuring system according to claim 1, further including an O-ring extending annularly around one of the first electrical contact or the second electrical contact and configured to engage the ring connector and the load cell in the locked position to provide a fluid tight seal therebetween.

10. A method of measuring a fluid flow by detecting a fluid weight change of a fluid collection system, comprising:
providing a load cell comprising a plate movable along a transverse axis orthogonal to a face of the plate, the plate including a first electrical contact;
coupling a ring connector to the load cell, the ring connector including a second electrical contact;
transitioning the ring connector from an unlocked position to a locked position on the load cell to bring the first electrical contact in communication with the second electrical contact;
attaching the fluid collection system to the ring connector; and
determining the fluid flow by determining a change in a downward force.

11. The method according to claim 10, wherein the downward force is transferred from the ring connector to the load cell along a second axis extending orthogonal to the transverse axis.

12. The method according to claim 10, wherein transitioning the ring connector from the unlocked position to the locked position includes rotating the ring connector relative to the load cell.

13. The method according to claim 10, wherein transitioning the ring connector from the unlocked position to the locked position comprises engaging an alignment pin on one of the plate or the ring connector with an alignment groove on the other of the plate or the ring connector.

14. The method according to claim 10, further including a biasing member positioned between the plate and an inner surface of the load cell, wherein the biasing member moves the plate away from the inner surface of the load cell when the ring connector is transitioned to the locked position.
